(19) United States
(12) Patent Application Publication
(10) Pub. No.: US 2011/0064509 A1
(43) Pub. Date: Mar. 17, 2011

(54) Air delivery apparatus for delivering air to a moving substrate in a printing press

(75) Inventors: David John Gagnon, Strafford, NH (US); Brian James Milliken, Newmarket, NH (US); James Everett Barnard, Dover, NH (US)

(73) Assignee: Goss International Americas, Inc., Durham, NH (US)

(21) Appl. No.: 12/586,118

(22) Filed: Sep. 17, 2009

(51) Int. Cl. B41J 15/00

(52) U.S. Cl. 400/619

(57) ABSTRACT

An air delivery apparatus for providing air to guide a web in a printing press that includes a source of compressed air and a web guiding device coupled to the source of compressed air is provided. The web guiding device includes a body and a guide. The body defines an internal cavity and has an axis, an inner surface, an outer surface, holes extending from the inner surface to the outer surface and an axial end having an opening coupling the internal cavity to ambient air. The guide couples the source of compressed air to the internal cavity and directs the compressed air in an axial direction away from the axial end toward the internal cavity so that the ambient air is forced into the internal cavity. A method of delivering air to guide a substrate is also provided.

The present invention relates generally to printing presses and more specifically to an air delivery apparatus for delivering air to a moving substrate in a printing press.

### BACKGROUND OF INVENTION

In printing presses, an air delivery system may deliver air to a web guiding device such as an angle bar or a former by using air generating equipment including a centrifugal or regenerative blower with an appropriately sized heat exchanger and companion plumbing components. The air may eliminate friction between the web guiding device and the web to improve transport of the web through a printing press and to prevent the web guiding device from marking the web. The air delivery system may be inefficient and in order to provide sufficient air flow from an interior of the web guiding device to the surface of the web guiding device, the air generating equipment may require a proportionally large amount of power. Additionally, the air generating equipment may include complex plumbing and may require substantial installation time and cost.

### BRIEF SUMMARY OF THE INVENTION

An air delivery apparatus for providing air to guide a web in a printing press that includes a source of compressed air and a web guiding device coupled to the source of compressed air is provided. The web guiding device includes a body and a guide. The body defines an internal cavity and has an axis, an inner surface, an outer surface, holes extending from the inner surface to the outer surface and an axial end having an opening coupling the internal cavity to ambient air. The guide couples the source of compressed air to the internal cavity and directs the compressed air in an axial direction away from the axial end toward the internal cavity so that the ambient air is forced into the internal cavity.

A method of delivering air to guide a substrate moving adjacent to a web guiding device that includes a body defining an internal cavity and having an inner surface, an outer surface, an axis, holes extending from the inner surface to the outer surface and an axial end having an opening coupling the internal cavity to ambient air is also provided. The method includes delivering compressed air that flows in an axial direction to the internal cavity of the web guiding device so that the ambient air flows through the opening into the internal cavity and is passed through the holes to guide the substrate moving adjacent to the outer surface.

### BRIEF DESCRIPTION OF THE DRAWINGS

The present invention is described below by reference to the following drawings, in which:

FIG. 1 schematically shows a cross-sectional view of a portion of a web guiding device according to an embodiment of the present invention guiding a moving web;

FIG. 2 schematically shows angle bars according to an embodiment of the present invention guiding a moving web; and

FIG. 3 schematically shows a former according to an embodiment of the present invention.

### DETAILED DESCRIPTION

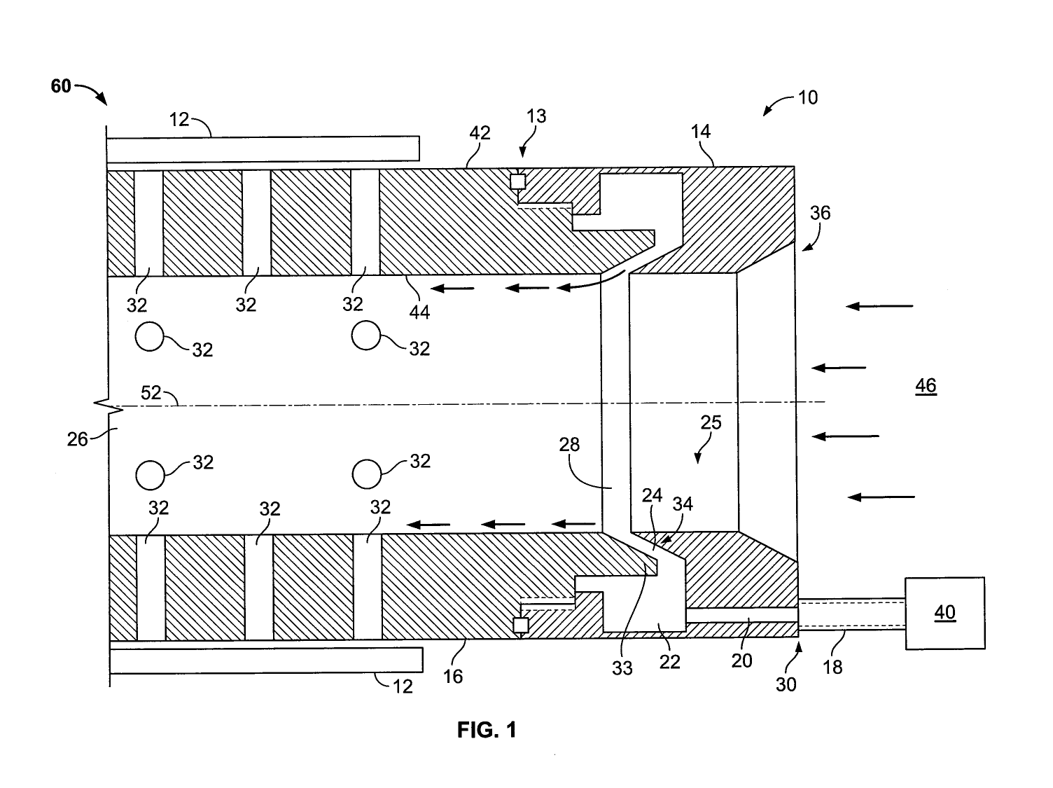

FIG. 1 schematically shows a cross-sectional view of a portion of an air delivery apparatus 60 according to an embodiment of the present invention guiding a moving web 12. Air delivery apparatus 60 includes a web guiding device 10 coupled to an air source 40. Web guiding device 10 includes a body 13 having an axis 52, an axial end portion 14 and a body portion 16. In this embodiment, axial end portion 14 and body portion 16 are not integral and are coupled together; however, in an alternative embodiment, axial end portion 14 and body portion 16 may be integral. Body 13 defines an internal cavity 26 and also includes an outer surface 42 adjacent to web 12 and an inner surface 44. In the embodiment shown in FIG. 1, web guiding device 10 is cylindrical and an axial end 30 of end portion 16 is annular, defining an opening 36 in axial end 30 that couples internal cavity 26 to the ambient air 46. A compressed air source 40 coupled to end portion 14 via a supply tube 18 provides compressed air to web guiding device 10. A guide 25 couples the compressed air from supply tube 18 to internal cavity 26 and directs the compressed air in an axial direction away from axial end 30. In this embodiment, guide 25 is integral with body 13; however, in other embodiments, guide 25 may not be integral with body 13. Guide 25 includes a channel 20 formed in end portion 14 that is coupled to supply tube 18 and a chamber 22 coupled to channel 20 that is formed between end portion 14 and body portion 16. In this embodiment, chamber 22 is annularly shaped and surrounds internal cavity 26. Guide 25 also includes a guiding gap 24 coupled to chamber 22 that is formed by an outwardly tapered peak 33 extending towards axial end 30 and an inwardly tapered peak 34 extending away from axial end 30. Guiding gap 24 is configured to direct compressed air in the axial direction away from axial end 30 of end portion 14 toward internal cavity 26 and holes 32 formed about a circumference of body portion 16. Holes 32 extend through outer surface 42 and inner surface 44 and allow air to exit internal cavity 26 radially to guide web 12, which may be adjacent to portions of outer surface 42. In this embodiment, outwardly tapered peak 33, inwardly tapered peak 34 and guiding gap 24, are also annularly shaped and also surround internal cavity 26 of web guiding device 10. In a preferred embodiment, an axial end of web guiding device 10 that is opposite axial end 30 is closed off from ambient air 46.

After air source 40 is turned on, an accumulation of air in chamber 22 forces a stream of air through guiding gap 24 into internal cavity 26 at a junction 28 between guiding gap 24 and internal cavity 26. Outwardly tapered peak 33 and inwardly tapered peak 34 are configured closely enough to each other such that the air stream exits guiding gap 24 at junction 28 at a sufficiently high velocity that the air stream at junction 28 creates a boundary-layer flow in web guiding device 10 that induces flow of the ambient air 46 through opening 36 at axial end 30 into internal cavity 26. After ambient air 46 enters opening 36, this air and the air stream flowing from guiding gap 24 create an air stream in internal cavity 26 that flows out of web guiding device 10 through holes 32. The air exiting holes 32 then acts on web 12 to assist in guiding web 12.

In other embodiments, one or more additional supply tubes 18 may supply compressed air to end portion 14, via air source 40 or additional air sources, such that air is introduced into chamber 22 at locations circumferentially spaced about axis 52. Also, if air is supplied to web guiding device 10 at locations circumferentially spaced about axis 52, at least one of chamber 22 and guiding gap 24 may not be a continuous annular ring and may be divided into sections circumferentially spaced about axis 52.

Air delivery apparatus 60 does not require blowers, heat exchangers and plumbing components and may reduce energy and equipment costs. Compressed air may be delivered at a lower temperature and may not require any additional cooling or treatment. Additionally, installation time and cost may be reduced and because air delivery apparatus 60 does not include any moving parts, reliability may be improved.

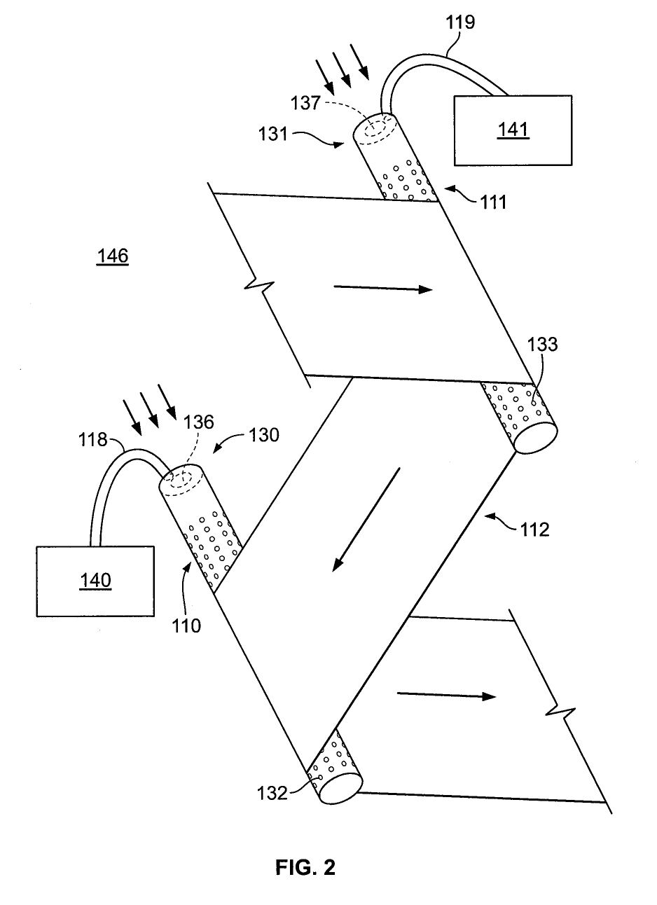

FIG. 2 schematically shows angle bars 110, 111 according to an embodiment of the present invention guiding a moving web 112. Angle bars 110, 111 are each configured as web guiding device 10 shown in FIG. 1. Air sources 140, 141 provide compressed air to respective guides 25 (FIG. 1) in respective angle bars 110, 111 via respective supply tubes 118, 119. In another embodiment, a single air source may supply air to both angle bars 110, 111. Respective guides 25 (FIG. 1) of angle bars 110, 111 provide compressed air axially into respective internal cavities 26 (FIG. 1), which causes ambient air 146 to enter through respective openings 136, 137 formed at axial ends 130, 131 of angle bars 110, 111, respectively. The air in internal cavities 26 (FIG. 1) is then forced out of holes 132, 133 towards moving web 112. Holes 132, 133 may be formed around the entire circumferences of angle bars 110, 111 or may only be formed in areas directly adjacent to where web 112 passes each angle bar 110, 111.

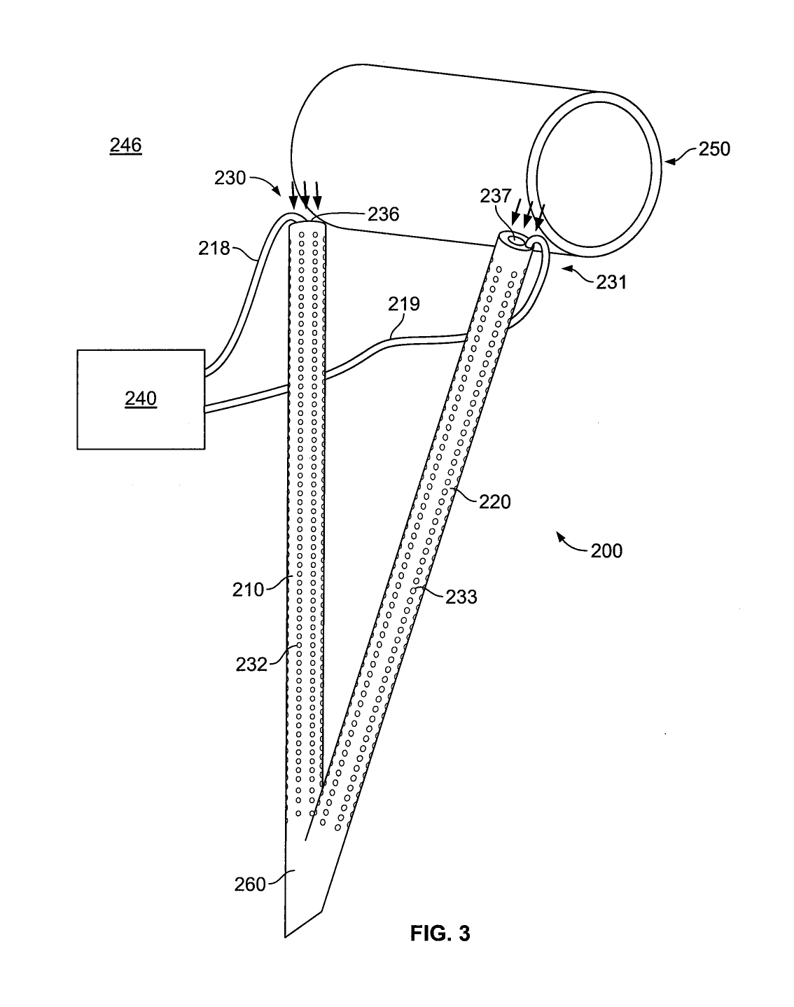

FIG. 3 schematically shows a former 200 according to an embodiment of the present invention. Former 200 includes an RTF 250, former bars 210, 220 and a former tip 260. A former board can fit over bars 210, 220. Former bars 210, 220 are each configured as web guiding device 10 shown in FIG. 1. An air source 240 provides compressed air to respective guides 25 (FIG. 1) in respective former bars 210, 220 via respective supply tubes 218, 219. In another embodiment, each former bar 210, 220 may be supplied with compressed air from a separate air source. Respective guides 25 (FIG. 1) of former bars 210, 220 provide compressed air axially into respective internal cavities 26 (FIG. 1), which causes ambient air 246 to enter through respective openings 236, 237 at axial ends 230, 231 of former bars 210, 220, respectively. Air is then forced out of holes 232, 233 formed in respective former bars 210, 220 towards a web that is transported over RTF 250 past former bars 210, 220 and is longitudinally folded by former tip 260. Holes 232, 233 may be formed around the entire circumferences of former bars 210, 220 or may only be formed in areas directly adjacent to where a web passes each former bar 210, 220.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. An air delivery apparatus for providing air to guide a web in a printing press comprising:
a source of compressed air; and
a web guiding device coupled to the source of compressed air including a body and a guide, the body defining an internal cavity and having an axis, an inner surface, an outer surface, holes extending from the inner surface to the outer surface and an axial end having an opening coupling the internal cavity to ambient air, the guide coupling the source of compressed air to the internal cavity and directing the compressed air in an axial direction away from the axial end toward the internal cavity so that the ambient air is forced into the internal cavity.

2. The air delivery apparatus recited in claim 1 wherein the guide is integral with the body and extends between the inner surface and the source of compressed air.

3. The air delivery apparatus recited in claim 2 wherein guide includes a guiding gap formed in the inner surface for directing the compressed air in the axial direction away from the axial end toward the internal cavity.

4. The air delivery apparatus recited in claim 3 wherein the guiding gap is defined by an outwardly tapered peak extending towards the axial end and an inwardly tapered peak extending away from the axial end.

5. The air delivery apparatus recited in claim 4 wherein the outwardly tapered peak and the inwardly tapered peak are annularly shaped.

6. The air delivery apparatus recited in claim 3 wherein the guiding gap is annularly shaped.

7. The air delivery apparatus recited in claim 3 wherein the guide includes a chamber formed between the inner surface and the outer surface coupling the source of compressed air to the guiding gap.

8. The air delivery apparatus recited in claim 7 wherein the web guiding device is cylindrically shaped and the chamber is annularly shaped.

9. The air delivery apparatus recited in claim 7 wherein the guide includes a channel formed in the body between the inner surface and the outer surface coupling the source of compressed air to the chamber.

10. The air delivery apparatus recited in claim 9 further comprising an air supply tube coupling the source of compressed air to the channel.

11. The air delivery apparatus recited in claim 7 wherein the web guiding device includes a body portion and an end portion coupled to the body portion and the chamber is formed between the end portion and the body portion.

12. The air delivery apparatus recited in claim 1 further comprising an air supply tube coupling the source of compressed air to the guide.

13. The air delivery apparatus recited in claim 1 wherein the web guiding device is an angle bar.

14. The air delivery apparatus recited in claim 1 wherein the web guiding device is a former bar.

15. A method of delivering air to guide a substrate moving adjacent to a web guiding device that includes a body defining an internal cavity and having an inner surface, an outer surface, an axis, holes extending from the inner surface to the outer surface and an axial end having an opening coupling the internal cavity to ambient air comprising:
delivering compressed air that flows in an axial direction towards the internal cavity of the web guiding device so that the ambient air flows through the opening into the internal cavity and is passed through the holes to guide the substrate moving adjacent to the outer surface.

16. The method recited in claim 15 wherein the web guiding apparatus further includes a guide integral with the body and the delivering compressed air to the internal cavity of the web guiding device includes directing the compressed air through the guide and towards the internal cavity.

17. The method recited in claim 16 wherein guide includes a guiding gap formed in the inner surface and the guiding gap directs the compressed air towards the internal cavity.

18. The method recited in claim 17 wherein the guide includes a chamber formed in the body between the inner surface and the outer surface coupling the compressed air to the guiding gap and the delivering compressed air toward the internal cavity of the web guiding device further includes filling the chamber with the compressed air before directing the compressed air with guiding gap towards the internal cavity.
